(19) United States
(12) Patent Application Publication
(10) Pub. No.: US 2009/0029025 A1
(43) Pub. Date: Jan. 29, 2009

(54) Low fat spread with ambient stability

(75) Inventor: Mimma Pernetti, Brussel (BE)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc.d/b/a Unilever

(21) Appl. No.: 12/220,359

(22) Filed: Jul. 24, 2008

(30) Foreign Application Priority Data
Jul. 26, 2007 (EP) EP07113239

(51) Int. Cl. A23L 1/0522; A23D 7/005

(52) U.S. Cl. 426/578; 426/602

(57) ABSTRACT

Fat continuous spreadable food product which comprise a dispersed aqueous phase a primary emulsifier, polyglycerol polyricinoleate, 5 to 30 wt % of fat and less than 1 wt % of hardstock and wherein the fat phase comprises at least 70 wt % of palm oil on fat phase, which is storage stable at ambient temperature and up to 40° C. The invention also provides for a method of making a spread without an inversion step.

### FIELD OF THE INVENTION

The invention relates to a low fat fat-continuous, spreadable food product which comprises a dispersed aqueous phase and polyglycerol polyricinoleate and very little to no hardstock fat and which is stable at temperatures of 30° C. and above.

### BACKGROUND TO THE INVENTION

Fat continuous spreadable food products are used by consumers as an underlayer on bread or toast. Examples of such spreadable food products are margarine, butter, low fat spreads.

For consumers with low income such as in developing countries it is desirable to have a spread that doesn't need to be kept at low temperatures, like 4 to 10° C., as these consumers often cannot afford a refrigerator. Regular margarines show phase separation, i.e. oil and/or water is released, if they are kept for a longer time, e.g. more than 1 to 5 days outside a refrigerator. Some developing countries are located in warmer climate region and the average temperature is well above 25 or even 30° C. These high temperatures accelerate the phase separation.

EP-A-968,655 discloses fat continuous food products which comprise about 60 wt % fat, a powerful emulsifier, polyglycerol polyricinoleate, and a monoglyceride. The fat content of the disclosed products is about 60 wt %. optionally the products contain a stabiliser such as a thickened polysaccharide or gelatin to prevent water separation upon storage. These products are suitably used for spreading on bread or shallow frying of foodstuff and are reported to break down easily in the mouth whereby taste and flavour components of the aqueous phase are released. It has been found that these products show some defects in long term storage at elevated temperatures as they are claimed to de-emulsify at 36° C.

EP-A-157,954 discloses edible water in oil emulsions, which are produced by incorporating as a component of the dispersed phase of the emulsion, hydrated, non-crystalline, intact, undissolved starch granules. The resulting emulsion allegedly easily breaks up in the mouth and shows good microbial stability upon storage. An essential feature of this product is that the starch is partially swollen by the aqueous phase i.e. it is swollen to submaximal degree.

These products were found to show insufficient storage stability. Furthermore the presence of large swollen starch particles can lead to a sandy mouthfeel to the food products.

EP-B-1343384 discloses water in oil emulsions which are ambient stable but still show good organoleptic properties. The products contain polyglycerol polyricinoleate but are usually high in fat and contain starch. Furthermore in addition to polyglycerol polyricinoleate a co-emulsifier needs to be present. The examples show spreads with lecithin as an ingredient.

Ambient stable spreads like EP-B-1343384 have often complicated emulsifier systems to prevent phase separation. However these extra ingredients add to the cost of the spread and the price of such a spread may become too high for low-income consumers.

Low fat spreads are often desired, as they provide fewer calories per serving. However it is difficult to make fat-continuous spread with a low fat content, e.g. lower than 30 wt % fat as the small amount of fat need to structure a high amount of water. Often hard fats are used to structure the emulsion. However, hard fats contain a lot of saturated fatty acids (SAFA), which are considered not healthy.

Another solution is often to structure the aqueous phase. Structuring of the aqueous phase can often be done by starch. However starch is an expensive ingredient and for low-income consumers the price of the spread may become too high if starch is included.

The way normally a low fat spread is made is by mixing an aqueous phase and a fat phase to obtain a water-continuous emulsion. The water-continuous emulsion is then inverted to form the desired fat-continuous spread. The inversion is an extra step in the process of low fat spread needed to obtain the fat-continuous spread. The extra step needs extra energy which increases the price of the spread.

EP 672 351 and EP 564 738 disclose a method for producing low fat emulsions of the type water in oil (W/O) and duplex emulsions oil in water in oil (O1/W/O2). It uses a method wherein an aqueous phase is dispersed in a fatty phase through a hydrophilic microporous membrane previously treated with the fatty phase. This is a very cumbersome process. For low-income markets this process would lead to products with a high price.

It is therefore an object of the current invention to provide a spread which is stable under storage at ambient and higher temperatures, spreads easily and shows good organoleptic properties. It is a further object of the current invention to provide a spread that has a low fat level. Furthermore, it would be desirable to have spread that doesn't need a high amount of hardstock. In addition, a low SAFA spread is desired. Furthermore another object of the invention is to provide a spread without a need for starch and/or complex emulsifier systems, i.e. systems with more than 1 emulsifier. Moreover another object of the invention is to provide a spread that can be made with a process without an inversion step. Also another object of the invention is to make a spread suitable for low-income markets. In addition, an object of the invention is to provide a spread that can be easily made by conventional spread processing without any extra equipment.

### SUMMARY OF THE INVENTION

It has surprisingly been found that a fat continuous product with 5 to 30 wt % of fat, 0.05 to 5 wt % of polyglycerol polyricinoleate (PGPR) and wherein the fat phase comprises more than 70 wt % of palm oil based on fat phase and wherein the spread comprises less than 1 wt % of hardstock, fulfils one or more of the objectives as indicated.

In a further aspect the invention relates to a process for the preparation of these products.

### DETAILED DESCRIPTION OF THE INVENTION

The invention relates to spreadable food products. Spreadable is defined as being easily spread with a knife on a substrate such as bread, without tearing the bread at the ambient temperature of the product during spreading.

In the description and claims where weight % is used this is eight % on total product weight unless otherwise is indicated.

Polyglycerol polyricinoleate will be denoted from hereon in this specification with its common abbreviation PGPR.

The products according to the invention are desirably stable under storage at temperatures at or above ambient temperature. This storage stability is determined by the test described in the examples. Products according to the invention show a phase separation of less than 5 wt % after storage at 35° C., preferably 40° C., for 10 weeks, more preferably 26 weeks.

Products according to the invention have only 5 to 30 wt % of fat. The product comprises less than 1 wt % (on spread) of hardstock fat. Hardstock fat is commonly used to structure the fat-phase. Hardstock according to the present invention is defined as a fat that has a solid fat content at 30° C. (N30) of more than 25 wt %, preferably more than 50 wt %, more preferably more than 80 wt %.

The fat phase of the product according to the invention comprise at least 70 wt %, preferably at least 75, and most preferred at least 80% of palm oil. In a preferred embodiment at least 10 wt % of the oil is not palm oil, more preferably at least 15 wt % and most preferably at least 20 wt % of the fat phase is not palm oil.

It was surprisingly found that the combination of at least 70 wt % of palm oil in the fat phase and less than 1 wt % of hardstock fat and PGPR provides a low fat spread that is ambient stable without a starch and lecithin and can be easily made without the need for an inversion step.

The fat phase of the products according to the invention may be blends of palm oil with other fats and oil. Suitable vegetable fats may be selected from the group comprising bean oil, sunflower oil, palm kernel oil, coconut oil, rapeseed oil, cotton seed oil, maize oil, or their fractions, or a combination thereof.

Products according to the invention comprise PGPR which is commercially available under the name Admul WOL from Quest-International. This ingredient is generally known to be excellent water in oil emulsifier.

The amount of PGPR in the products of the invention is from 0.05 to 5 wt % on total product weight. Higher amounts lead to products which do not easily de-emulsify in the mouth upon consumption and will hence not show the desired organoleptic properties. Food products comprising PGPR in amounts below 0.05 wt % are not stable under elevated storage temperatures and show phase separation upon storage at 35° C. for several weeks. Preferably the amount of PGPR in food products according to the invention is from 0.1 to 1 wt %, more preferably 0.2 to 0.4 wt %.

Products according to the invention in contrast to most low fat spreads do not need starch. Although spreads of the current invention may contain starch as it further improves the mouthfeel of the spread. Preferred starches are starches of which at least 50 wt % is fully gelatinised. More preferably the starches at least 70 wt %, more preferred at least 80 wt %, even more preferred at least 90 wt % is fully gelatinised. Even more preferred all starch is fully gelatinised starch. In preferred food products according to the invention, the aqueous phase comprises a fully gelatinised starch selected from any of the main starch groups: wheat, potato, rice, maize, waxy rice or waxy maize.

Examples of suitable starches include Remyrice™, Tapioca™, Purity LFS™

The amount of starch in the food product according to the invention depends somewhat on the type of chosen starch and is preferably from 0.2 to 5 wt %, more preferred from 0.7 to 3 wt %, most preferred from 1 to 2 wt %. Very high levels of starch were found to lead to a slow perception of flavour and salt release, probably due to too high a droplet viscosity.

To ensure homogeneous distribution of the aqueous phase in the continuous fat phase, the droplet size distribution D_{3,3} Of the dispersed aqueous phase is preferably less than 20 μm, more preferably from 2 to 10 μm. The method to determine D_{3,3} is illustrated in the examples.

It will be appreciated that the droplet size can be controlled by adjusting the processing conditions in the unit operations: e.g. higher rotational speed in a scraped surface heat exchanger will produce correspondingly smaller water droplet size distributions.

The food product according to the invention comprises from 5 to 30 wt % of a fat. Preferably the amount of fat is from 5 to 20 wt %, more preferably from 10 to 15 wt %.

In addition to the primary water-in-oil emulsifier polyglycerol polyricinoleate, the food product according to the invention may comprises another emulsifier, a co-emulsifier. This co-emulsifier is preferably also a water-in-oil emulsifier. More preferably this co-emulsifier is selected from the group comprising distilled monoglycerides, citric acid esters of monoglycerides, di-acetyl acetic acid esters of monoglycerides, lactic acid esters of monoglyceride, mono-diglycerides, polyglycerol esters of fatty acids or sorbitan esters of fatty acids.

The most preferred co-emulsifier is a distilled monoglyceride. Even more preferred are combinations of a monoglyceride comprising a saturated fatty acid residue and a monoglyceride comprising an unsaturated fatty acid residue.

The amount of co-emulsifier depends on the type and effectiveness of the emulsifier selected and can be determined by the person skilled in the art. Other factors influencing the amount of emulsifier that is required to obtain storage stable products are the amount of fat and the amount of polyglycerol polyricinoleate.

As a general guidance the amount of emulsifier is preferably from 0.05 to 1.5 wt %, more preferred from 0.1 to 0.7 wt %, most preferred from 0.15 to 0.5 wt %.

In case combinations are used of a monoglyceride comprising a saturated fatty acid residue and a monoglyceride comprising an unsaturated fatty acid residue, their total amount is preferably from 0.3 to 0.4 wt %.

The pH of the aqueous phase can be set to the desired value, among others to influence acidic or basic taste impression and to influence microbial stability. Preferably the pH of the aqueous phase in food products according to the invention is from 4.3 to 5.5.

The food products according to the invention optionally contain Other ingredients such as preservatives, vitamins, taste and flavour components, colorants such as beta-carotene, anti-oxidants, or other non-starch based stabilisers, or thickeners.

The food product according to the invention can be prepared by any suitable process to prepare such products.

However, the product according to the invention does not need an inversion step, which is commonly needed in low fat spreads. The omission of such inversion step simplifies the process to manufacture the spread according to the invention considerably. The costs of manufacturing go down and the product is then even more suitable for low-income consumers. Furthermore, the simple process allows easy implementation and the process becomes available for low-technical areas which may decrease the costs even further.

According to one embodiment an aqueous phase is prepared comprising water soluble ingredients and separately a fat phase is prepared comprising fat phase ingredients and the aqueous phase and fat phase are mixed to obtain a fat-continuous emulsion without inversion.

Preferably the aqueous phase is brought to a temperature of 60 to 95 and the fat phase is brought to a temperature of from 50 to 70° C. and in a further step the aqueous phase and the fat phase are mixed at a temperature of around 60° C.

Fat phase ingredients are ingredients which are soluble or dispersible in the fat phase. Examples of such ingredients include emulsifiers such as monoglycerides and polyglycerol polyricinoleate; antioxidants, colorants.

The aqueous phase is preferably heated to a temperature between 85 to 95° C. for about 15 to 45 minutes. After cooling the aqueous phase to a temperature from 50 to 70° C., optionally further ingredients may be added to the aqueous phase. Examples of ingredients which can be added at this moment in the process are salts, water soluble or water dispersible antioxidants, flavour components, protein, thickeners, stabilisers, preservatives or acids.

The mixing of the fat phase and the aqueous phase is preferably carried out by using a series of processing equipment, or unit operations, which are common for production of margarine. For example the use of a pin stirrer in combination with a high shear heat exchanger unit, optionally repeating these unit operations several times, is suitable for the preparation of the food products according to the invention.

After mixing of the aqueous phase and the fat phase the resulting product is filled into packaging material. Filling is preferably at a temperature range from 5 to 15° C.

The invention is now illustrated by the following non-limiting examples.

### EXAMPLES

General

Storage Stability Test

Food product was stored in a plastic container at 10, 20, 30, 35 and 40° C. for up to 26 weeks. After storage the amount of phase separation was determined by visual examination of the product surface. Storage stable products show a phase separation of less than 5 wt % upon storage at 35° C. for at least 10 weeks, preferably at least 26 weeks. Preferably the phase separation is less than 5 wt % upon storage at 40° C.

Method to Determine D_{3,3} and E-Sigma

The water droplet size (D_{3,3}) and e-sigma were measured using a well known low resolution NMR measurement method. Reference is made to Alderliesten, M.; Part. Part. Syst. Charact. 8 (1991), 237-241. D_{3,3} is the average droplet size (μm) with e-sigma as the standard deviation, which is a measure for the width of the droplet-size distribution.

Stevens Firmness

The firmness of the products is determined by measuring the force required to penetrate a cylindrical probe in the product. The peak force (by custom expressed in gram, g; 1 g=9.81 mN) is recorded, and averaged over triplicate measurements. Sample height 5 cm; cylindrical probe of 0.5 inch thickness; compression rate 2 mm/s; penetration depth 20 mm. A suitable machine may be a Stable Micro Systems TA-XT2 Texture Analyzer.

Method to Determine Solid Fat Content

The solid fat content can be measured by a suitable analytical method such as NMR. The method used is low resolution NMR with Bruker Minispec apparatus. Reference is made to the Bruker minispec application notes 4, 5 and 6.

The percentage of solid fat determined by the low resolution NMR technique is defined as the ratio of the response obtained from the hydrogen nuclei in the solid phase and the response arising from all the hydrogen nuclei in the sample. The product of this ratio and one hundred is termed the low resolution NMR solids percent. No correction is made for variations in the proton density between solid and liquid phase. The NMR solids percent for a sample measured at t ° C. was given the symbol Nₜ.

Suitable instruments adapted to determine the solids fat content are the Bruker Minispecs p₂₀i™, pc20™, pc120™, pc120s™, NMS₁₂₀™ and MQ20™.

Stabilization and tempering procedure was as follows:

melt fat at 80° C.

5 minutes at 60° C.

60 minutes at 0° C.

30-35 minutes at each chosen measuring temperature.

### Example 1

Ingredients are listed in table 1

TABLE 1
ingredients in wt %

| | % |
|---|---|
| Palm oil | 14 |
| Sunflower oil | 6 |
| Fully hydrogenated rapeseed oil | 0.45 |
| polyglycerol polyricinoleate | 0.3 |
| dimodan up-t/b | 0.3 |
| beta-carotene | 0.04 |
| flavour | 0.01 |
| total fat phase | 21.1 |
| demi water | 76.16917 |
| sodium chloride | 2.5 |
| potassium sorbate | 0.1 |
| citric acid anhydrate | 0.085 |
| flavour | 0.04 |
| EDTA | 0.00583 |
| total water phase | 78.9 |
| TOTAL | 100 |

Processing

In a pre-mix tank a mixture was prepared of the fat, hardstock, monoglyceride, PGPR, flavour and colorant at a temperature of about 60° C. In another, separate vessel the water soluble ingredients were mixed in water of 60° C. The water phase is then mixed with the oil phase, followed by cooling and shearing in a series of A- and C-units™ repeated as necessary to achieve a plastic structure which could be easily packed at around 20° C. in a suitable packaging material.

Results

Stability

Stability was tested by droplet size (D_{3,3}), firmness (stevens value) at storage at different temperatures and from cycling regimes. The change in droplet size is measure for the stability of the spread, the lower the droplet size the more stable and the lower the relative distribution (e-sigma) the better.

TABLE 2
Results at storage temperature

| Measurement | D_{3,3} | e-sigma | S (g) | Spreadability |
|---|---|---|---|---|
| At filling | 5 | 1.3 | | |
| 1 week at 15° C. | 4.25 | 1.5 | 251 | 2 |
| 1 week at 5° C. | | | 470 | 5 |
| 3 weeks at 5° C. | 4.8 | 1.7 | 542 | 5 |
| 1 week at 25° C. | | | 87 | 1.5 |
| 3 weeks at 25° C. | 3.7 | 1.6 | 102 | 1.5 |
| 1 week at 40° C. | | | 52 | 1 |
| 3 weeks at 40° C. | 3.4 | 1.8 | 48 | 1.5 |

Samples were filled and stored for 1 week at 15° C. (top 2 rows of table). Then after 1 week at 15° C. samples were stored at indicated temperature for indicated time (bottom 6 rows of table) and measured. Spreadability is rated from 1 (good) to 5 (poor).

TABLE 3
Cycling

| Measurement | D_{3,3} | e-sigma | Stevens (g) | Spreadability |
|---|---|---|---|---|
| 40/5 | 4.1 | 1.9 | 310 | 5 |
| 40/15 | 3.23 | 1.7 | 75 | 2 |
| 40/25 | 3.7 | 1 | 87 | 1.5 |

Samples were filled and stored for 1 week at 15° C. Then after 1 week at 15° C. samples were temperature cycled according to the following regime:

Stored for 8 hours at a first indicated temperature, and then 16 hours at the second indicated temperature. This was done for 3 days and then the samples were measured. For example 40/5 means 8 hours stored at 40° C. and then 16 hours stored at 5° C., this was repeated for 3 days.

The resulting products showed good stability i.e. no phase separation at 35° C. and had a good melting behaviour on consumption. Also the droplet size and e-sigma indicate an acceptable stability of the spread even after 3 weeks at 40° C. Furthermore, the products were able to withstand temperature cycling. The results also indicate that the spread is at it best for spreading at ambient temperatures.

1. Fat-continuous spreadable food product comprising a dispersed aqueous phase, a primary water-in-oil emulsifier polyglycerol polyricinoleate, wherein the amount of fat is from 5 to 30 wt %, the amount of polyglycerol polyricinoleate is from 0.05 to 5 wt %, wherein the amount of hardstock fat is less than 1 wt % on product and wherein the fat comprises at least 70 wt % of palm oil on fat phase.

2. Food product according to claim 1 wherein the amount of fat is from 5 to 20 wt %, preferably from 10 to 15 wt %.

3. Food product according to claim 1 wherein the amount of palm oil is at least 75 wt %, more preferably at least 80 wt %.

4. Food product according to claim 1 wherein the amount of polyglycerol polyricinoleate is from 0.1 to 0.4 wt %.

5. Food product according to claim 1 wherein the water phase comprises a starch, preferably at least 50 wt % gelatinised, more preferably fully gelatinised.

6. Food product according to claim 1 wherein the droplet size distribution D_{3,3} of the dispersed aqueous phase is less than 20 μm, preferably from 2 to 10 μm.

7. Food product according to claim 1 wherein in addition to the primary emulsifier a co-emulsifier is present in an amount of up to 0.5 wt % preferably selected from the group comprising distilled monoglycerides, citric acid esters of monoglycerides, di-acetyl acetic acid esters of monoglycerides, lactic acid esters of monoglyceride, mono-diglycerides, polyglycerol esters of fatty acids or sorbitan esters of fatty acids.

8. Process for the preparation of a food product according to claim 1 wherein an aqueous phase is prepared comprising water soluble ingredients and separately a fat phase is prepared comprising fat phase ingredients and in a further step the aqueous phase and the fat phase are mixed to obtain a fat-continuous emulsion without inversion.
